(19) United States
(12) Patent Application Publication
(10) Pub. No.: US 2012/0238216 A1
(43) Pub. Date: Sep. 20, 2012

(54) SYSTEMS AND METHODS FOR MANAGING BLUETOOTH DEVICE PAIRINGS

(75) Inventors: Scott Hallowell, Arvada, CO (US); Chris Durand, Superior, CO (US); John Bahr, Superior, CO (US)

(73) Assignee: POLYCOM, INC., Pleasanton, CA (US)

(21) Appl. No.: 13/050,622

(22) Filed: Mar. 17, 2011

(51) Int. Cl. H04B 7/00

(52) U.S. Cl. 455/41.3

(57) ABSTRACT

A system and method manages Bluetooth connections between Bluetooth devices. A first Bluetooth device can have a virtual Bluetooth device associated with it. A virtual Bluetooth device can include Bluetooth parameters and values that when adopted by a second Bluetooth device, would allow the first and second Bluetooth devices to begin communicating as already paired devices. The first Bluetooth device can be configured to allow a Bluetooth connection with the second Bluetooth device only if the second Bluetooth device has the Bluetooth parameters associated with the first Bluetooth device. An administrator server can control access to virtual Bluetooth devices based on access privileges. The first Bluetooth device can identify the second Bluetooth device using methods other than Bluetooth communication. The first Bluetooth device can then access virtual Bluetooth device associated with the second Bluetooth device and establish a secure connection with the second Bluetooth device.

### FIELD OF THE INVENTION

The present invention relates generally to communication systems, and more particularly to managing Bluetooth devices.

### BACKGROUND

Bluetooth wireless technology is a short-range communications system intended to replace cables connecting portable and/or fixed electronic devices. Two or more Bluetooth devices can communicate over an established wireless network, also known as piconet. All devices within a piconet share the same physical channel for sending and receiving data. Typically, each piconet has one device acting as a master device, while all other devices act as slave devices. Establishing communication, whether as a master device or a slave device, is carried out by the individual devices themselves. There is no central authority that dictates which device can or cannot communicate with another device.

Bluetooth does not provide a managed solution. In other words, there is no central authority that can control which Bluetooth devices can connect with which other Bluetooth devices. As an example, FIG. 1 illustrates a scenario in which device 101 approaches two Bluetooth devices 102 and 103. Because Bluetooth communications are established in an ad hoc manner, device 101 could potentially establish communication with either one of devices 102 and 103, i.e., device 101 may end up establishing communication with the device that is first to respond to an inquiry scan, or page procedure. Some devices may allow the user of device 101 to select which one of the devices 102 and 103 it wishes to establish communication with. However, this places a burden on the user to know how to select a device. Furthermore, devices that lack user interface (e.g., headset) cannot even provide the option of selecting a device to the user. In any case, control of establishing communication does not lie outside of the realm of the devices themselves.

Secure communications between Bluetooth devices may require the devices to establish a pairing. Two Bluetooth devices are paired when they share a key that can be used to communicate securely. Once paired, the two devices can encrypt communication data based on the shared key. Each device maintains the pairing even after initial communication with that device terminates so that the already established pairing information can be used for secure communications in the future without re-executing the time consuming pairing process. Certain applications require a device (e.g., cell phone, laptop computer, etc.) to communicate with several other devices. Thus, each device will have to maintain several pairings in memory. For devices with limited memory capacity, storing all pairing information associated with all the devices it has paired with may not be possible.

Furthermore, devices such as cell phones and laptop computers are frequently replaced due to failure, loss, upgrade, or other reasons. A replacement device may not contain any pairings that the original device had in memory. Thus, a user carrying the replacement device would have to re-pair the replacement device with each device it communicates with. This process can be tedious and burdensome to the user, especially if the user is inexperienced with Bluetooth technology.

### SUMMARY

A system and method for managing Bluetooth connections between Bluetooth devices is presented. A first Bluetooth device can have a virtual Bluetooth device associated with it. A virtual Bluetooth device can include Bluetooth parameters and values that when adopted by a second Bluetooth device, would allow the first and second Bluetooth devices to begin communicating as already paired devices. The first and second Bluetooth devices can be fixed or mobile devices. The first Bluetooth device can be configured to allow a Bluetooth connection with the second Bluetooth device only if the second Bluetooth device has the Bluetooth parameters associated with the first Bluetooth device. One of the parameters of the virtual Bluetooth device can include a secret key, or link key.

An administrator can control the access to a Bluetooth device by controlling access to the associated virtual Bluetooth device. The administrator can be a server maintaining access privileges of one set of Bluetooth devices to another set of Bluetooth devices. A Bluetooth device can identify another Bluetooth device by any method other than Bluetooth. This can include RFID, bar code, etc. Once the Bluetooth device has been identified, the identity of the Bluetooth device can be sent to the administrator server with a request for its associated virtual Bluetooth device. The administrator server can reply based on access privileges. Alternatively, the administrator server can allow a Bluetooth device to store virtual Bluetooth devices associated with all the Bluetooth devices that it has permission to access. As a result, the Bluetooth device need not contact the administrator server each time it needs to connect to another Bluetooth device.

The two Bluetooth devices can begin establishing Bluetooth connection as already paired devices. Because the two Bluetooth devices know each other's identity, they can skip the Inquiry stage of the Bluetooth connection process and establish a physical link. Also, because the secret key, or the link key, is known by both devices, they can skip the time consuming Pairing step and establish a logical link. The devices can then perform one-way or two-way authentication using the shared link key. After authentication, the two devices can begin secure communication.

Access privileges for a Bluetooth device can be dynamic, i.e., they can change over time. The administrator server can control access of virtual Bluetooth devices based on the changing access privileges. This can involve denying request for virtual Bluetooth devices associated with inaccessible Bluetooth devices. Additionally, the administrator server can communicate with a Bluetooth device to add or delete virtual Bluetooth devices stored in the device's memory.

### BRIEF DESCRIPTION OF THE DRAWINGS

Exemplary embodiments of the present invention will be more readily understood from reading the following description and by reference to the accompanying drawings, in which:

FIG. 1 shows the ad-hoc manner in which Bluetooth devices establish communication;

FIG. 2A depicts fixed devices with their associated virtual mobile devices;

FIG. 2B shows exemplary Bluetooth parameters for fixed devices and virtual mobile devices;

FIG. 3 depicts an example where a mobile device with a fixed device using parameters of a virtual mobile device that is associated with that fixed device;

FIG. 4A shows an exemplary data structure for establishing access privileges;

FIG. 4B shows exemplary ways in which an administrator server can allow access to a virtual mobile device associated with a fixed device;

FIG. 5 illustrates exemplary steps performed by a mobile device for accessing and using a virtual mobile device associated with a identified fixed device;

FIG. 6 illustrates exemplary steps performed by a fixed device and a mobile device to establish secure communication;

FIG. 7 depicts mobile devices with their associated virtual fixed devices; and

FIG. 8 illustrates an exemplary block diagram of a Bluetooth fixed or mobile device.

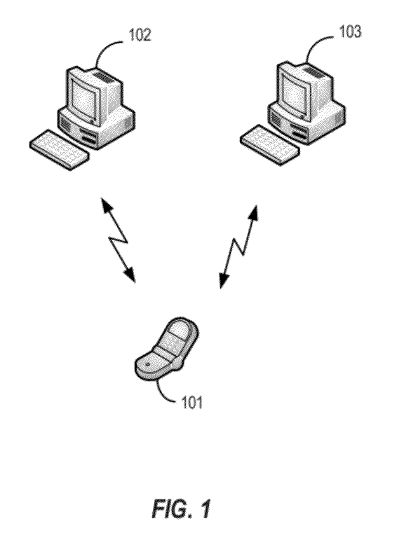

### DETAILED DESCRIPTION

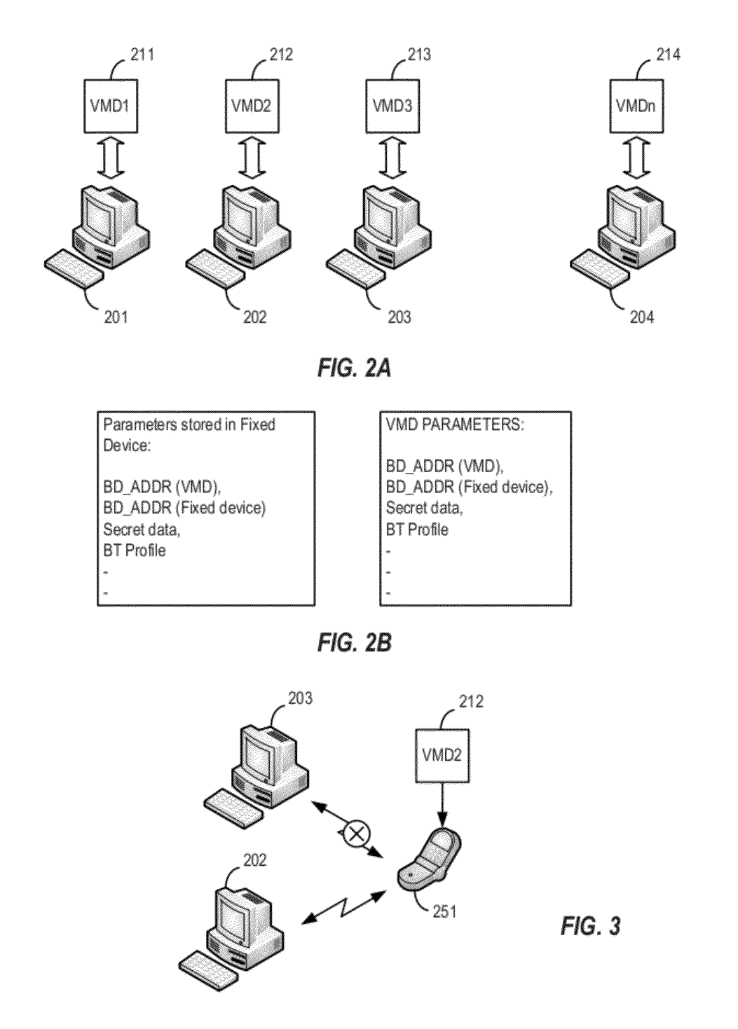

FIG. 2A illustrates an example where each fixed device has an associated paired virtual mobile device. Fixed devices 201-204 can be desktop computers, laptops, medical measuring equipment, body area network (BAN), body sensor network (BSN), industrial measurement equipment, programmable logic controllers (PLCs), etc. Fixed devices 201-204 can be associated with virtual mobile devices VMD1-VMDn 211-214, respectively. Virtual mobile devices (VMD) 211-214 can include a set of parameters with corresponding values that can be used by another device to establish a Bluetooth connection with the associated fixed device. For example, VMD1 211 can include parameters and data that would be recognized as trustworthy only by fixed device 201. In the context of Bluetooth, a fixed device and its virtual mobile device can be considered to be paired devices, i.e., the two devices share some secret data (such as a Link Key).

FIG. 2B shows exemplary parameters associated with a fixed device and a paired virtual device. The fixed device parameters can include Bluetooth device address BD_ADDR of the virtual mobile device, secret data (e.g., Link Key), etc. Parameters for the VMD can include Bluetooth device address of the VMD and the associated fixed device, secret data (e.g., Link Key), etc. Because the fixed device and the VMD of FIG. 2B are assumed to be paired, they will share the same secret data. For example, the secret data (e.g., Link Key) for the fixed device and the VMD would be the same.

Parameters for both VMD and fixed device can also include BT profiles. BT profiles specify the required functions and features of each layer in the Bluetooth system, which layers can include PHY (physical layer), Baseband, Link Manager, and L2CAP (logical link control and adaptation protocol), and any additional layers such as application layers. Such profiles can include the Generic Access Profile (GAP), Generic Attribute Profile (GATT), etc. BT profiles can, for example, determine whether the device is to communicate using Basic Rate or Low Energy state. Additionally, profiles can instruct the fixed device, for example, to establish communication with only those devices whose BD_ADDR is same as the one for the corresponding VMD. Additionally, the profiles can instruct the mobile device that adopts the VMD parameters to use the BD_ADDR specified in the VMD as its own address.

FIG. 3 shows an example where a mobile device 251 can establish communication with one of two fixed devices. Mobile device 251 can include devices such as laptops, notebooks, personal digital assistants, phones, etc. Referring to FIG. 2A, device 202 has VMD2 212 as the associated virtual mobile device, while fixed device 203 has VMD3 213 as the associated virtual mobile device. To be able to communicate with fixed device 202 only, the mobile device 251 can assume the identity defined by the parameters stored in VMD2 212. Mobile device 251 can then wirelessly transmit connection initiation messages having an access code that is derived from the destination address of the fixed device 202 as specified in VMD2 212. Fixed device 203 is in the vicinity of mobile device 251, and can also receive these connection initiation messages. However, fixed device 203 will ignore these messages because the access code of the messages will not match the address of fixed device 203. Consequently, mobile device 251 can potentially establish connection only with fixed device 202.

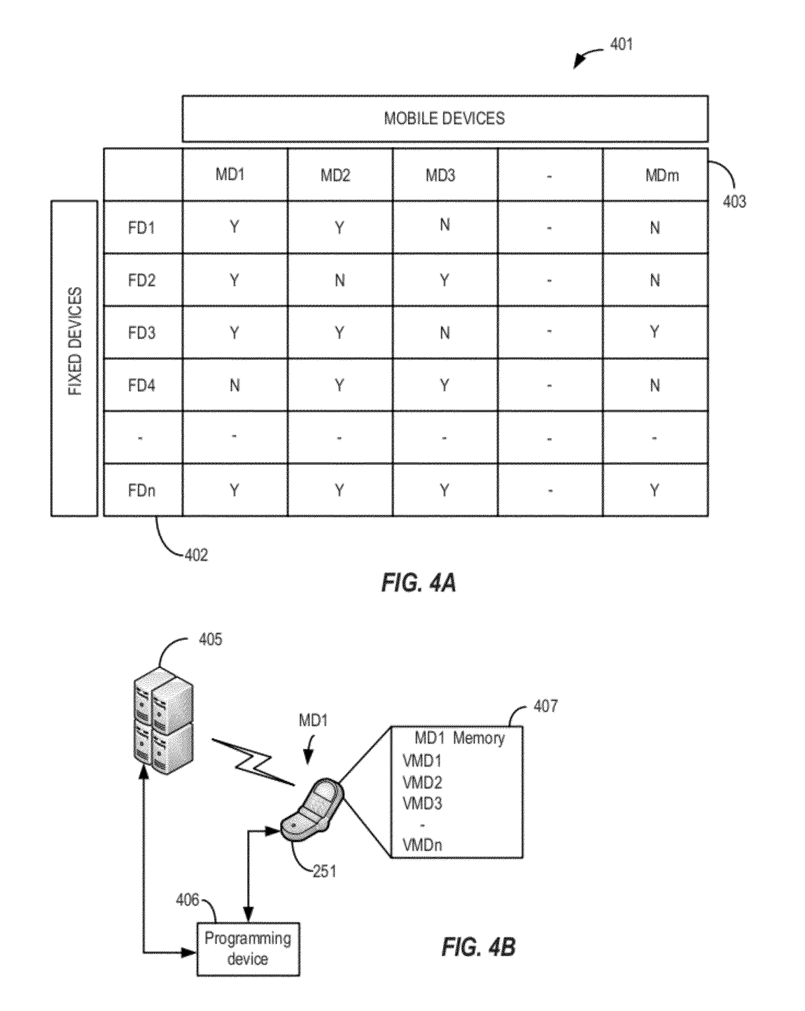

An administrator can control accessibility to fixed devices by determining which mobile devices can have access to a particular VMD. For example, FIG. 4A shows an accessibility table 401 that can be maintained by the administrator. The leftmost column 402 lists a set of n fixed devices FD1-FDn (these fixed devices can be similar to the 201-204 depicted in FIG. 2). The topmost row 403 lists a set of m mobile devices MD1-MDm. Accessibility privileges of each mobile device to each fixed device is denoted by ‘Y’ or ‘N’; Y denoting that the mobile device has access to that fixed device and N denoting that the mobile device does not have access to the fixed device. For example, mobile device MD1 has access to FD1, FD2, FD3, etc., but does not have access to FD4. It is understood that table 401 is only an example, and that the administrator may use any data structure to indicate accessibility. For example, the administrator can maintain accessibility lists associated for each mobile device MD1-MDm, where an accessibility list can include all the fixed devices to which the mobile device is allowed access. Furthermore, the accessibility privileges depicted in table 401 are not static, and can change over time.

A mobile device can access a fixed device only if it is able to access the VMD associated with that fixed device. The administrator can therefore control access to fixed devices by way of controlling access to their associated VMDs. For example, referring again to FIG. 4A, the administrator can limit mobile device MD2's access to only fixed devices FD1, FD3, FD4, . . . , and FDn, by limiting its access only to virtual mobile devices VMD1, VMD3, VMD4, . . . , and VMDn.

Although FIG. 4A shows access privileges of a set of mobile devices with relation to a set of fixed devices, it is understood that such privileges can be defined between two set of mobile devices, or two sets of fixed devices, or two sets of mixed mobile and fixed devices.

The administrator can provide access to VMDs in a number of ways. In one way, the administrator can upload and store VMDs in the mobile device's memory. FIG. 4B shows an example where memory 407 of mobile device 251 can store VMDs associated with fixed devices, to which it has access. Memory 407 can be a volatile or non-volatile memory such as RAM, ROM, Flash, etc. As an example, if the mobile device 251 is MD1, then memory 407 can include virtual mobile devices VMD1, VMD2, VMD3, . . . , VMDn. Note that from the access table 401 in FIG. 4A, mobile device MD1 does not have access to fixed device FD4. Therefore, memory 407 does not include VMD4. The desired VMDs can be stored in mobile device 251 wirelessly by server 405, which can be maintained by the administrator. Server 405 can maintain the access table 401 shown in FIG. 4A, and VMDs associated with fixed devices FD1-FDn. Accordingly, when mobile device 251 is deployed, the mobile device 251 can request server 405 for VMDs associated with allowable fixed devices. VMDs can also be loaded into the mobile device 251 memory 407 via its physical I/O port using a programmable device 406. The mobile phone I/O port can be a serial or parallel port. Programmable device 406 can include the access table 401 for mobile device 251 and VMDs associated with fixed devices FD1-FDn or it can access this data from server 405.

In another way, the server 407 may send only a single VMD to the mobile device 251. For example, the mobile device 251 may identify the particular fixed device it wishes to be connected to and send the fixed device identity to the server 407. Upon receiving this request, server 407 can check the access privileges of mobile device 251 for the identified fixed device, and if allowed, server 407 can reply with the VMD associated with that fixed device only.

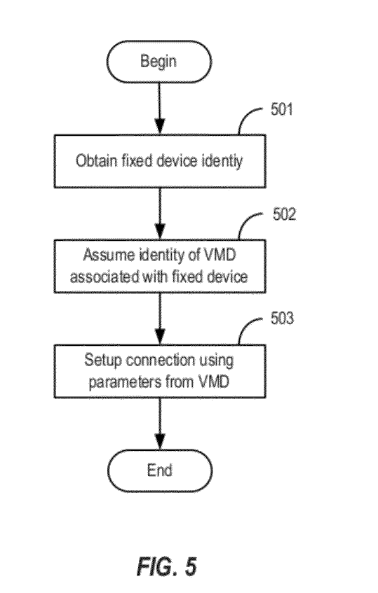

FIG. 5 shows a flowchart illustrating the steps performed by mobile device 251 to establish connection with a fixed device using the associated virtual mobile device. From FIG. 3 it is clear that for mobile device to establish communication with a fixed device, the mobile device 251 can assume the identity of the virtual mobile device associated with the fixed device. There may be several virtual mobile devices to choose from. Thus, to select the one associated with the desired fixed device, the mobile device 251, in step 501, can determine the identity of the fixed device.

Mobile device 251 can identify a fixed device in many ways. In one way, the mobile device can include a scanner, such as a bar code scanner, while the fixed device can have its own identity encoded in a machine readable format, such as a bar code, affixed on or near the fixed device. The mobile device 251 can then use the scanner to scan the identity of the fixed device. Alternatively, other ways of identification, such as radio frequency identification (RFID) devices, infra-red (IR) badges, laser readable IDs, etc., can also be employed. The mobile device 251 may also use global positioning system (GPS) or other location identifying system to determine the mobile device's proximity to a fixed device. When the mobile device 251 is within a predetermined distance (e.g., 1-3 ft.) from the fixed device, the mobile device 251 can automatically identify the fixed device without any action from the user. Thus, the mobile device 251 can identify the fixed device based either on active user identifying action (e.g., scanning bar code, IR badge) or with passive user identification action (e.g., bringing mobile device closer to RFID tag, GPS, etc.).

Once the fixed device has been identified, the mobile device 251 can acquire the VMD associated with the identified fixed device (step 502). The VMD can be accessed from memory (FIG. 4B, 407), or can be requested from server 405 (FIG. 4B). Upon receiving the appropriate VMD, the mobile device 251 can assume the identity specified by the VMD. For example, referring again to FIG. 2B, mobile device 251 can use values for parameters such as BD_ADDR, secret data, etc., specified in the VMD.

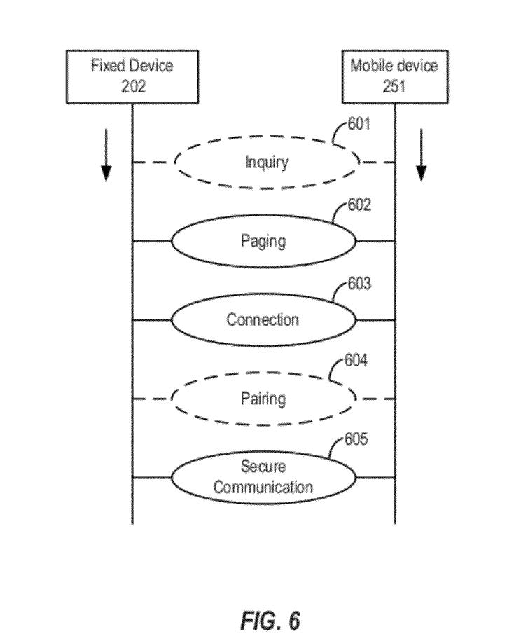

In step 503, the mobile device 251 can begin setting up a connection with the fixed device. FIG. 6 shows an exemplary flow of setting up of a Bluetooth connection between a fixed device 202 and the mobile device 251. In a typical Bluetooth connection procedure between two devices, the two devices successfully carry out Inquiry, Paging, Connection, and Pairing, before beginning secure communication of data. However, because the fixed device 202 and the mobile device 251 already have each others Bluetooth device addresses (BD_ADDR), they do not need to carry out the Inquiry step 601. Additionally, the fixed device 202 and the mobile device 251 already know the shared secret in the form of a Link Key that was included in the secret data. Therefore, the two devices can also optionally skip the Pairing step 604 as well.

During paging 602, the fixed device 202 and the mobile device 251 can establish a physical channel and then a physical link between them. Establishing a physical channel means that the two devices are synchronized over a RF hopping sequence. The hopping sequence is pseudo-random in nature and is derived from the BD_ADDR and clock of the master device. Either the fixed device 202 or the mobile device 251 can assume the role of a master device. Additionally, master/slave roles can be switched at any time. Assuming that the mobile device 251 is the master, the mobile device can transmit page train messages on the derived hopping sequence. Each page train message can include a device access code derived from the BD _ADDR of the slave device, i.e., fixed device 202. In this manner, only the fixed device 202 can accept these page train messages. The fixed device 202 has the BD_ADDR of the master device, and can therefore determine the same hopping sequence as determined by the mobile device 251. Although all Bluetooth devices include the same clock frequency of 3.2 kHz, they may drift due to differences in manufacture, temperature, etc. Therefore, the fixed device 202 can use the page train messages (specifically, the device access code) to synchronize its clock with the mobile device clock by incorporating a clock offset. Once the synchronization is complete, a physical channel can be said to have been established. The mobile device 251 and the fixed device 202 can then move on to establishing a physical link by communicating on alternating master and slave transmission time slots over the established physical channel. Note that the fixed device can also store the value of the clock offset that allows the fixed device to synchronize with the mobile device. In such cases, it may not be necessary to even enter the paging procedure.

In the connection 603 stage, the mobile device 251 and the fixed device 202 can establish additional logical transport and logical links on top of the already established physical link. These can include transport and link layers such as Asynchronous Connection-Oriented link (ACL), ACL control logical link (ACL-C), User ACL link (ACL-U), etc. The fixed device 202 and mobile device 251 can use their respective BT link managers (LM) to setup the links with link manager protocol (LMP). For example, the LM of mobile device 251 can send the command LMP_host_connection_req to the LM of the fixed device 202 for requesting an ACL connection. Subsequently, the LM of the fixed device 202 can reply with the message LMP_accepted indicating that the request to establish a connection has been accepted.

For two devices that do not have a Link key, the connection setup will enter a pairing procedure 604 that allows the two devices to generate and share a Link key. Generally, this procedure takes anywhere from a few milliseconds to a few seconds. But the fixed device 202 and the mobile device 251 already have a shared link key. Therefore, the fixed device 202 and the mobile device 251 can skip the pairing procedure 604. Instead, the fixed device 202 and the mobile device 251 can go ahead and exchange messages that indicate that an ACL connection setup has been completed.

The fixed device 202 and the mobile device 251 can then authenticate each other. The authentication can use a challenge-response scheme in which a device's knowledge of a secret key can be checked through a 2-move protocol using symmetric secret keys. For example, the fixed device 202 can generate and send a random number AU_RAND to the mobile device 251. The mobile device 251 can use AU_RAND, the BD_ADDR of the fixed device, and the Link key as an input to an authentication code to generate a result SRES, and send the result to the fixed device 202. The fixed device can use the AU_RAND, the BD_ADDR of the mobile device 251, and the link key as an input to the same authentication code to generate SRES′. If the SRES generated by the fixed device 202 is the same as the SRES′ received from the mobile device 251, then the mobile device 251 is considered to be authenticated by the fixed device 202. Alternatively, the above described one way authentication can be initiated by the mobile device 251 instead of the fixed device 202. In other words, the mobile device 251 is the one that generates and sends the random number AU_RAND to the fixed device 202 and verifies the received result SRES. Two-way authentication can also be carried out, in which both the fixed device 202 and the mobile device 251 carry out separate one-way authentication operations to authenticate each other. If authentication fails, for example, when SRES is not equal to SRES′, the fixed or mobile device can abort the establishment of the Bluetooth connection.

Once a Bluetooth connection is established, the mobile device 251 and the fixed device 202 can begin secure communication using the common Link Key in step 605. All data between the mobile device 251 and the fixed device can be encrypted by the Link Key or another mutually agreed key derived from the Link Key.

Other logical channels using protocols such as L2CAP (logical link control and adaptation protocol), can also be established. L2CAP provides a multiplexing role allowing many different applications running on the devices to share an ACL logical link. Applications on one of the two devices interface with L2CAP using channel-oriented interface to create connections to equivalent entities in the other device. Data associated with these applications can employ the secure connection setup in step 605.

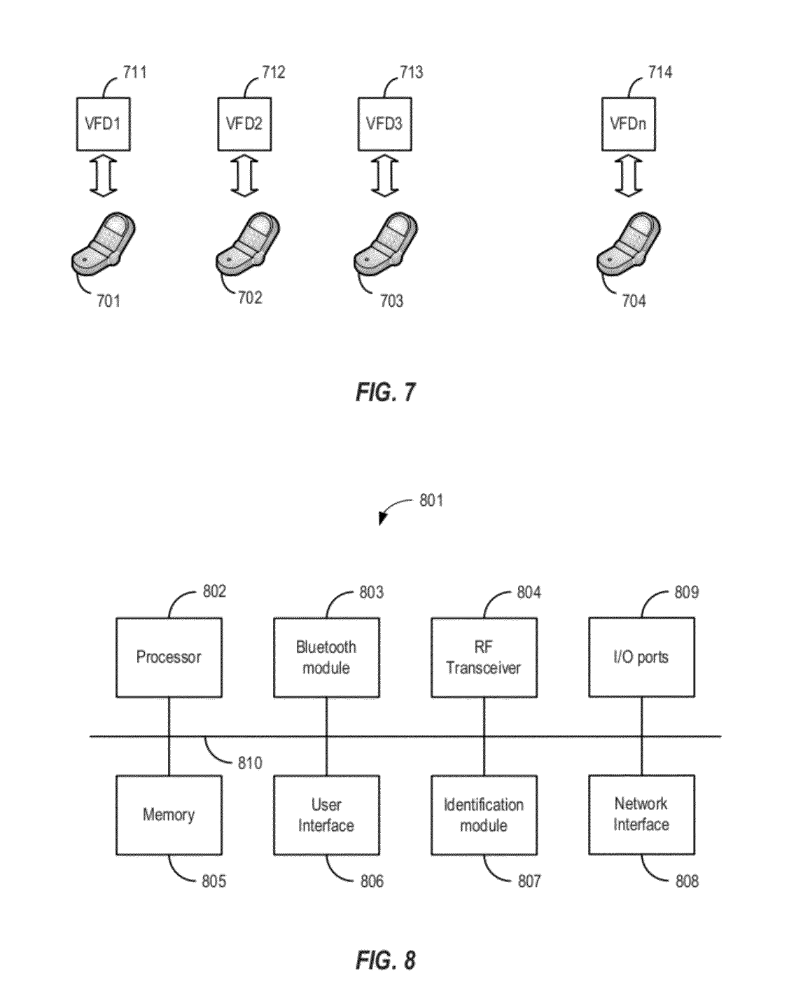

While FIG. 2 showed an example in which the virtual devices were associated with fixed devices, FIG. 7A shows an example in which the virtual devices are associated with mobile devices. Mobile devices 701-704 have associated paired virtual fixed devices VFD1-VFDn 711-714. In this case, fixed devices can assume the identity specified in virtual fixed devices VFD1-VFDn 711-714 in order to communicate with mobile devices 701-704. Virtual fixed devices VFD1-VFDn 711-714 can be stored in a server or stored in memory of the fixed device. When a fixed device wants to communicate with a mobile device 701-704, the fixed device can acquire the VFD associated with the selected mobile device by requesting it from the server or accessing it from memory.

Each of the mobile devices 701-704 can have its own identity encoded in a machine readable format, such as a bar code, affixed on or near the mobile device. While each fixed device 711-714 can have a bar code scanner for identifying a mobile device. Previously discussed identifying methods such as RFIDs, GPS, etc. can also be employed.

Permissions for accessing VFDs can be maintained at an administrator server. A table similar to the one shown in FIG. 4A can be maintained. The procedure for establishing a secure connection between the a fixed device and a mobile device can be similar to the one described in FIG. 6 for fixed device 202 and mobile device 251. However, in this instance, the fixed device can be the one initiating the Bluetooth connection.

Another example of establishing communication between two Bluetooth devices can exclude the use of identification methods such as RFID, bar code, GPS, etc. In such an example, in contrast to that shown in FIG. 6, the two devices can enter the Inquiry step 601. Thus, the identity of the other device is determined using standard BT methods instead of RFID, bar code, GPS, etc. Once the identity of the other BT device is known, this identity is communicated to the server 405 to obtain the secret data. If the server determines that the first BT device has access privileges to communicate with the other BT device, then the server can reply with the BT parameters of the other device. Subsequently, the first BT device can use the BT parameters of the other device to establish communication with the other BT device.

Access privileges associated with Bluetooth devices can change over time due to devices being lost, non-functional, or because access policies have changed. As a result, permissions stored at the administrator server, for example, in FIG. 4A can dynamically change. The administrator server can apply the new permissions in distributing VMDs or VFDs to BT devices. For example, in scenarios where a Bluetooth device requests for virtual deice parameters from the administrator server each time it wishes to connect to another Bluetooth device, the administrator server can simply respond to the request based on the most recent access privileges. Thus, if the requesting Bluetooth device had permission to access some device in the past but does not own such privileges anymore, the administrator server can deny the request for virtual device parameters corresponding to that device. In scenarios where the administrator server stores virtual device parameters in the Bluetooth device memory, the administrator server can initiate a communication with the device to modify the contents of the memory so that they reflect the most updated access privileges for that Bluetooth device.

FIG. 8 shows a block diagram of an exemplary Bluetooth device 801. Device 801 can include processor 802, a Bluetooth module 803, an RF transceiver 804, memory 805, a user interface 806, an identification module 807, a network or communication interface 808, an I/O port 809, and an interconnecting bus 810. Device 801 can have additional modules depending upon the type of application the device is being used in. For example, the device 801 can have a sensor module for sensing patients temperature, blood pressure, and other vitals. Each of the modules can be implemented using a microcontroller, microprocessor, application specific integrated circuit (ASIC), field programmable gate array (FPGA), firmware, software, or any combination thereof. Bluetooth module 803 can include the functionality of a Bluetooth device as specified by the Bluetooth standard. RF transceiver 804 can include a BT transceiver, an 802.11 wireless LAN transceiver, etc. Memory 805 can include volatile as well as non-volatile memory. Contents of memory MEM can include BT VMD parameters if the device 801 is a mobile device, or BT fixed device parameters if device 801 is a fixed device (as shown in FIG. 2B). User interface 806 can include a display, keypad, keyboard, etc. Identification module 807 can be included for identifying another device. For example, identification module 807 can be a bar code scanner, an RFID reader, etc. Identification module 807 can also be a device for revealing the identity of the device 801, for example an RFID tag, etc. Network interface 808 can be a wired or wireless network interface. Device 801 can used the network interface to communicate with the administrator server (e.g., FIG. 4B, 405) for accessing virtual devices. I/O port 809 can be a serial or parallel port that allows external devices to communicate with the device 801 for data transfer. For example, I/O port 809 can be a USB port for communicating virtual mobile device parameters with the administrator server (e.g., FIG. 4B).

A person skilled in the art will appreciate that in the embodiments discussed herein, access to a Bluetooth device can be controlled irrespective of whether the device is a fixed device or a mobile device. The distinction between a fixed device and mobile device has been maintained here to aid discussion and in no way limits the scope of the invention to such devices. To the extent that certain details of Bluetooth devices have not been discussed, such details can be found in the Bluetooth specification available at the Bluetooth website.

The above description is illustrative and not restrictive. Many variations of the invention will become apparent to those skilled in the art upon review of this disclosure. The scope of the invention should therefore be determined not with reference to the above description, but instead with reference to the appended claims along with their full scope of equivalents.

What is claimed is:

1. A method for managing Bluetooth (BT) communications at a first BT device, the first BT device configured to communicate with a second BT device, comprising:
identifying the second BT device;
accessing BT parameters associated with the identified second BT device based on access privileges; and
using the BT parameters to begin BT communication with the identified second BT device as an already paired device,
wherein the BT parameters include a first BT device address, and wherein the first BT device adopts the first BT device address as its own BT device address.

2. The method of claim 1, wherein the BT parameters include a secret key.

3. The method of claim 1, wherein accessing BT parameters comprises accessing BT parameters from a memory in the first BT device.

4. The method of claim 1, wherein accessing BT parameters comprises accessing BT parameters from an administrator server.

5. The method of claim 1, wherein identifying the second BT device comprises using a barcode scanner to scan a barcode associated with the second BT device.

6. A first Bluetooth (BT) device configured to communicate with a second BT device comprising:
a identification module configured to identify the second BT device;
a processor configured to access BT parameters associated with the identified second BT device based on access privileges and to begin BT communication with the second BT device as an already paired device,
wherein the BT parameters include a BT device address, the BT device address being adopted by the first BT device as its own BT device address.

7. The device of claim 6, wherein the BT parameters include a secret key.

8. The device of claim 6, further comprising a memory coupled to the processor, wherein the BT parameters are stored in the memory.

9. The device of claim 6, further comprising a communication interface coupled to the processor, wherein the processor accesses the BT parameters from an administrator server via the communication interface.

10. The device of claim 6, wherein identification module comprises a barcode scanning device.

11. The device of claim 6, wherein the identification module does not use BT communications to identify the second BT device.

12. The device of claim 6, wherein the first BT device is a mobile device and the second BT device is a fixed device.

13. The device of claim 6, wherein the first BT device is a fixed device and the second BT device is a mobile device.

14. A method for managing Bluetooth (BT) communications between a first BT device and a plurality of second BT devices by an administrator server, the administrator server comprising a server memory, the method comprising:
maintaining access data at the server memory, the access data specifying access privileges of the first BT device to the plurality of second BT devices; and
controlling access of the first BT device to the plurality of second BT devices based on the access data.

15. The method of claim 14, further comprising:
maintaining at the server memory BT parameters associated with each of the plurality of second BT devices, the BT parameters enabling the first BT device to begin communication with the associated second BT device as an already paired device.
wherein the controlling access comprises allowing the first BT device access to the BT parameters based on the access data.

16. The method of claim 15, wherein the BT parameters include a secret key.

17. The method of claim 15, wherein allowing the first BT device access comprises the server providing BT parameters associated with one of the plurality of second BT devices in response to a request by the first BT device over an electronic communication channel.

18. The method of claim 15, wherein allowing the first BT device access comprises the server storing in a memory of the first BT device the BT parameters associated with one or more of the plurality of second BT devices.

19. The method of claim 14, wherein access privileges vary over time.

20. A first Bluetooth (BT) device configured to communicate with a second BT device, comprising:
a BT module storing BT parameters, the BT module configured to establish a BT connection with a second BT device only if the second device has the same BT parameters; and
a readable identifier that includes a reference to the BT parameters.

21. The device of claim 20, wherein the BT parameters include a secret key.

22. The device of claim 20, wherein the readable identifier is a bar code.

23. The device of claim 20, wherein the readable identifier is an RFID tag.

24. The device of claim 20, wherein the readable identifier is a distance from the second BT device.

25. The device of claim 20, wherein the BT module does not enter a pairing procedure with the second BT device.

26. The device of claim 20, wherein the BT module carries out an authentication procedure to authenticate the second BT device.

27. The device of claim 26, wherein the BT module aborts the establishment of the BT connection with the second BT device if the BT module fails to authenticate the second BT device.
